(19) United States
(12) Patent Application Publication
(10) Pub. No.: US 2016/0162093 A1
(43) Pub. Date: Jun. 9, 2016

(54) HYBRID TOUCH-BASED ELECTRONIC DEVICE AND METHOD FOR CONTROLLING THE SAME

(71) Applicant: Samsung Electronics Co., Ltd., Suwon-si (KR)

(72) Inventors: Jung-Won KIM, Suwon-si (KR); Jae-Hyung PARK, Suwon-si (KR)

(21) Appl. No.: 14/959,694

(22) Filed: Dec. 4, 2015

(30) Foreign Application Priority Data
Dec. 5, 2014 (KR) 10-2014-0174214

(51) Int. Cl. G06F 3/041; G06F 3/044

(52) U.S. Cl. CPC G06F 3/0414; G06F 3/044; G06F 3/0412; G06F 2203/04103; G06F 2203/04106

(57) ABSTRACT

An electronic device capable of detecting a touch and a pressure is provided. The electronic device includes a display interposed between a transparent protective window and a pressure sensing panel, a touch panel on the transparent protective window and electrically connected to a first control circuit to sense a touch input and identify a location of the touch input, a black sheet directly adhered onto a back surface of the display, an insulating layer laminated to a conductive pattern included in the pressure sensing panel under the black sheet, uniformly disposed across an area of the pressure sensing panel substantially aligned with the view area of the display and electrically connected to a second control circuit, wherein the second control circuit identifies a pressure of the touch input and wherein the location and the pressure of the touch input are provided to a main control circuit as a user input.

### CROSS-REFERENCE TO RELATED APPLICATION(S)

This application claims the benefit under 35 U.S.C. §119(a) of a Korean patent application filed on Dec. 5, 2014 in the Korean Intellectual Property Office and assigned Serial number 10-2014-0174214, the entire disclosure of which is hereby incorporated by reference.

### TECHNICAL FIELD

The present disclosure relates to an electronic device, for example, a hybrid touch-based electronic device and a method for controlling the same.

### BACKGROUND

Generally, display devices are devices for outputting images or image information, and may be installed in most electronic devices having an information and communication function. With the development of electronic and electric technologies, the capabilities of display devices have also been remarkably improved, leading to the improvement of display qualities. As touch panels are integrated into the display devices, the display devices become useful as input devices as well as output devices. An electronic device including a display device calculates, based on an input onto a touch panel, a horizontal element, for example, a position, motion, or the like, of the input. The display device also changes a user experience corresponding to the horizontal element by using the calculated horizontal element.

According to conventional techniques, an electronic device calculates, based on a touch input of various types, a horizontal position of the touch input. For example, the electronic device may sense a change in a capacitance between two electrodes included in the touch panel to determine an intersecting point between the two electrodes as a position of the input.

However, conventionally, as an electronic device includes only a type of a touch panel that calculates a horizontal position of a touch input, a user experience that may be provided to a user of the electronic device has been limited. For example, even when an electronic device includes two types of touch panels, the touch panels merely calculate a horizontal position of a touch input in different manners, without calculating a pressure applied by the input. Therefore, the electronic device may not provide a user with a user experience based on a pressure applied by a touch input.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described above. Accordingly, an aspect of the present disclosure is to provide a touch-based electronic device which includes a first touch panel for calculating a horizontal position of a touch input and a second touch panel for calculating a digitalized value corresponding to a pressure applied by the touch input, thereby recognizing the touch input based on both the horizontal position of the input and the digitalized value of the input and providing various user experiences to users, and a method for controlling the touch-based electronic device.

Other objects to be provided in the present disclosure may be understood by embodiments described below.

In accordance with an aspect of the present disclosure, an electronic device capable of detecting a touch and a pressure is provided. The electronic device includes a display interposed between a transparent protective window and a pressure sensing panel, a touch panel contacted on the transparent protective window and electrically connected to a first control circuit, wherein the touch panel is configured to sense a touch input and the first control circuit identifies a location of the touch input, a black sheet directly adhered onto a back surface of the display, an insulating layer configured to be laminated to a conductive pattern, and the conductive pattern, included in the pressure sensing panel and disposed under the black sheet, uniformly disposed across an area of the pressure sensing panel substantially aligned with the view area of the display and electrically connected to a second control circuit, wherein the second control circuit identifies a pressure of the touch input, and wherein the location of the touch input and the pressure of the touch input are provided to a main control circuit as a user input.

In accordance with another aspect of the present disclosure, an electronic device is provided. The electronic device includes a housing including a first surface facing in a first direction, and a second surface facing in a second direction opposite from the first direction, a glass plate forming at least a portion of the first surface of the housing, a display interposed between the glass plate and the second surface of the housing, the display including a first surface including a screen and facing in the first direction, and a second surface facing in the second direction, a touch panel integrated into the display, a conductive pattern interposed between the second surface of the display and the second surface of the housing, wherein the conductive pattern is formed substantially parallel to the second surface of the housing, and is spaced apart from the second surface of the display, a first control circuit electrically connected to the touch panel, and a second control circuit electrically connected to the conductive pattern, wherein the first control circuit is configured to detect a touch input for selecting a position on the display, based at least partially on a change in capacitance associated with the touch panel, wherein the second control circuit is configured to detect pressure of the touch input against the glass plate, based at least partially on a change in capacitance associated with the conductive pattern, and wherein the conductive pattern includes a repeating pattern of polygons (e.g., rectangular shape or a square shape) across an area between the second surface of the display and the second surface of the housing.

In accordance with further aspects of the present disclosure, an electronic device is provided. The electronic device includes a housing including a first surface facing in a first direction, and a second surface facing in a second direction opposite from the first direction, a window member forming at least a portion of the first surface of the housing, and a display panel disposed between the window member and the second surface of the housing, wherein the display panel includes a first surface including a screen and facing in the first direction, and a second surface facing in the second direction, a touch panel integrated into the display panel, a conductive pattern disposed between the second surface of the display panel and the second surface of the housing, wherein the conductive pattern is formed substantially parallel to the second surface of the housing, and is spaced apart from the second surface of the display panel, a first touch control module electrically connected to the touch panel, and a second touch control module electrically connected to the conductive pattern, wherein the first touch control module is configured to detect a position of a touch input on the glass plate, based at least partially on a change in capacitance associated with the touch panel, wherein the second touch control module is configured to detect pressure of the touch input against the glass plate, based at least partially on a change in capacitance associated with the conductive pattern, and wherein the conductive pattern includes a repeating pattern of polygons across a planar area between the second surface of the display panel and the second surface of the housing.

In accordance with further aspects of the present disclosure, a method for operating an electronic device is provided, the method including receiving a touch input on the glass plate, detecting a position of the touch input, using the first control circuit, based at least partially on a change in capacitance associated with the touch panel, detecting pressure of the touch input against the glass plate, using the second control circuit, based at least partially on a change in capacitance associated with the conductive pattern, and performing an action based at least partially on the detected position of the touch input and the detected pressure of the touch input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to an embodiment of the present disclosure;

FIG. 2 is a block diagram of an electronic device according to an embodiment of the present disclosure;

FIG. 3 is a perspective view of an electronic device according to an embodiment of the present disclosure;

FIG. 4 is a cross-sectional view of a display device of an electronic device according to an embodiment of the present disclosure;

FIG. 5 is a floor plan of an electronic device according to an embodiment of the present disclosure;

FIG. 6 is a floor plan of an electronic device according to an embodiment of the present disclosure;

FIG. 7 is a cross-sectional view of a display device of an electronic device according to an embodiment of the present disclosure;

FIGS. 8, 9, 10, 11, 12, 13, and 14 illustrate arrangements of a second touch panel disposed on a display device of an electronic device according to various embodiments of the present disclosure;

FIG. 15 is a flowchart of a three-dimensional (3D) input method for an electronic device according to an embodiment of the present disclosure; and

FIG. 16 is a block diagram of an input/output (I/O) interface associated with an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Relative terms referred to as illustrated in the drawings, such as a ‘front surface’, a ‘rear surface’, a ‘top surface’, a ‘bottom surface’, and the like, may be replaced with ordinal numbers such as “first”, “second”, and so forth. The order of components, such as “first”, “second”, and so forth, is the order in which they are mentioned or the arbitrarily set order, and thus may be changed arbitrarily. The terms are used for distinguishing one component from another component. For example, a first user device and a second user device are both user devices, and indicate different user devices. Also, a first component may be referred to as a second component and likewise, a second component may also be referred to as a first component, without departing from the teaching of the present disclosure.

Terms used in various embodiments of the present disclosure are intended to describe an embodiment, rather than to limit the various embodiments of the present disclosure. As used herein, the singular forms are intended to include the plural forms as well, unless the context clearly indicates otherwise. Terms “include” or “may include” used in various embodiments of the present disclosure indicate an existence of disclosed function, operation, or element, but do not limit an existence of one or more other functions, operations, or elements. Terms “include” or “has” used in the present disclosure should be understood that they are intended to indicate an existence of feature, number, step, operation, element, item or any combination thereof, disclosed in the specification, but should not be understood that they are intended to previously exclude an existence of one or more other features, numbers, steps, operations, elements, or any combination thereof or possibility of adding those things.

Unless otherwise defined, all terms, including technical and scientific terms, used herein have the same meaning as commonly understood by one of ordinary skill in the art to which various embodiments belong. It will be further understood that terms, such as those defined in commonly used dictionaries, should be interpreted as having a meaning that is consistent with their meaning in the specification with the context of the relevant art as understood by the artisan at the time of disclosure and will not be interpreted in an idealized or overly formal sense unless expressly so defined herein.

In the present disclosure, an electronic device may be an arbitrary device including a touch panel and may be referred to as a terminal, a portable terminal, a mobile terminal, a communication terminal, a portable communication terminal, a portable mobile terminal, a display device, or the like.

For example, the electronic device may be a smart phone, a cellular phone, a navigation system, a game console, a television (TV), a vehicle head unit, a laptop computer, a tablet computer, a personal media player (PMP), a personal digital assistant (PDA), or the like. The electronic device may be implemented as a pocket-size portable communication terminal having a wireless communication function. The electronic device may be a flexible device or a flexible display device.

The electronic device may perform an operation by communicating with an external electronic device such as a server or interworking with the external electronic device. For example, the electronic device may transmit an image captured by a camera and/or position information detected by a sensor unit to the server over the network. The network may be, but not limited to, a mobile or cellular communication network, a local area network (LAN), a wireless local area network (WLAN), a wide area network (WAN), Internet, or a small area network (SAN).

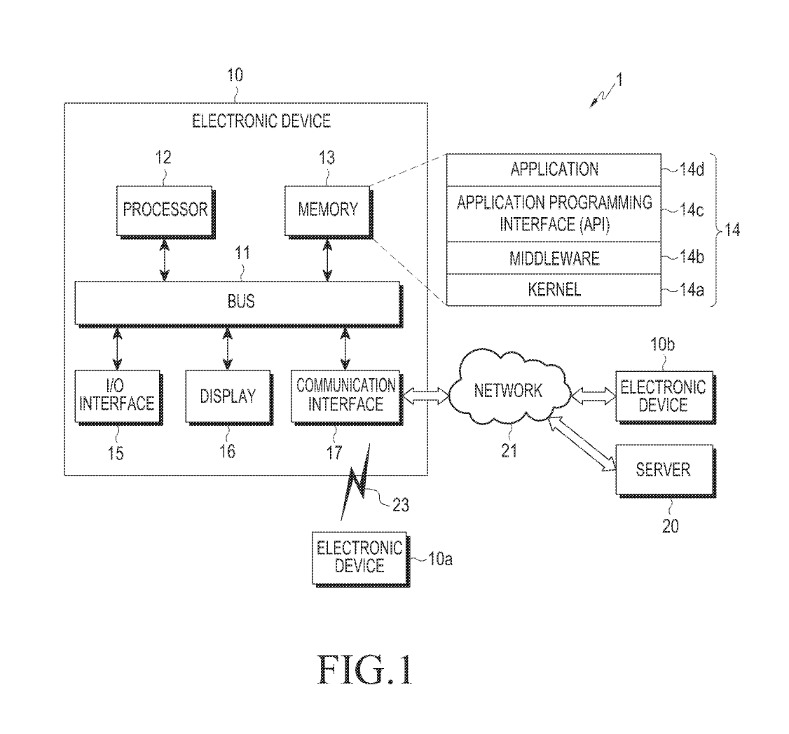

FIG. 1 illustrates a network environment including an electronic device according to an embodiment of the present disclosure.

Referring to FIG. 1, an electronic device 10 in a network environment 1, according to various embodiments of the present disclosure, will be described. The electronic device 10 may include a bus 11, a processor 12, a memory 13, an input/output (I/O) interface 15, a display 16, and a communication interface 17. In some embodiments of the present disclosure, the electronic device 10 may omit at least one of the foregoing components or additionally include other components.

The bus 11 may include a circuit for interconnecting the components, including the bus 11, thee processor 12, the memory 13, the input/output (I/O) interface 15, the display 16, and the communication interface 17, and delivering communication, for example, a control message and/or data among the above noted components.

Although not shown, the processor 12 may include one or more of a central processing unit (CPU), an application processor (AP), and a communication processor (CP). The processor 12 may perform, for example, an operation or data processing associated with control and/or communication of at least one other component of the electronic device 10.

The memory 13 may include a volatile and/or nonvolatile memory. The memory 13 may store, for example, commands or data associated with at least one other components of the electronic device 10. According to an embodiment of the present disclosure, the memory 13 may store software and/or a program 14. The program 14 may include, for example, a kernel 14a, middleware 14b, an application programming interface (API) 14c, and/or an application 14d. At least a part of the kernel 14a, the middleware 14b, and the API 14c may be referred to as an operating system (OS).

The kernel 14a controls or manages, for example, system resources, for example, the bus 11, the processor 12, or the memory 13, used to execute an operation or a function implemented in other programs, for example, the middleware 14b, the API 14c, or the application 14d. The kernel 14a provides an interface through which the middleware 14b, the API 14c, or the application 14d accesses separate components of the electronic device 10 to control or manage the system resources.

The middleware 14b may work as an intermediary for allowing, for example, the API 14c or the application 14d to exchange data in communication with the kernel 14a. In regard to task requests received from the application 14d, the middleware 14b performs control, for example, scheduling or load balancing, with respect to the task requests, for example, by giving at least one of the applications 14d priorities for using a system resource, for example, the bus 11, the processor 12, or the memory 13, of the electronic device 10.

The API 14c is an interface used for the application 14d to control a function provided by the kernel 14a or the middleware 14b, and may include, for example, at least one interface or function, for example, a command, for file control, window control, image processing or character control.

The I/O interface 15 serves as an interface for delivering a command or data input from a user or another external device to other components of the electronic device 10. The I/O interface 15 may also output a command or data received from other components of the electronic device 10 to a user or another external device.

The display 16 may include, for example, a liquid crystal display (LCD), a light emitting diode (LED) display, an organic light emitting diode (OLED) display, a micro-electromechanical system (MEMS) display, or an electronic paper display. The display 16 may display various contents, for example, a text, an image, video, an icon, or a symbol, to users. The display 16 may include a touch screen, and receives a touch, a gesture, proximity, or a hovering input, for example, by using an electronic pen or a part of a body of a user.

The communication interface 17 sets up communication, for example, between the electronic device 10 and an external device, for example, a first external electronic device 10a, a second external electronic device 10b, or a server 20. For example, the communication interface 17 is connected to a network 21 through wireless or wired communication to communicate with the external device, for example, the second external electronic device 10b or the server 20.

The wireless communication may use, as a cellular communication protocol, for example, at least one of long term evolution (LTE), LTE-advanced (LTE-A), code division multiple access (CDMA), wideband CDMA (WCDMA), a universal mobile telecommunication system (UMTS), wireless broadband (WiBro), or global system for mobile communications (GSM)). The wired communication may include, for example, at least one of a universal serial bus (USB), a high definition multimedia interface (HDMI), a recommended standard (RS)-232, and a plain old telephone service (POTS). The network 21 may include a telecommunications network, for example, at least one of a computer network, for example, a local area network (LAN) or a wide area network (WAN)), Internet, and a telephone network.

Each of the first external electronic device 10a and the second external electronic device 10b may be a device of the same type as or a different type than the electronic device 10. According to an embodiment of the present disclosure, the server 20 may include a group of one or more servers, such as the server 20. According to an embodiment of the present disclosure, some or all of operations performed by the electronic device 10 may be performed in other one or more electronic devices, for example, the electronic devices 10a and 10b or the server 20. According to an embodiment of the present disclosure, when the electronic device 10 needs to perform a function or a service automatically or based on a request, the electronic device 10 may request another electronic device, for example, the electronic devices 10a and/or 10b or the server 20, to execute at least some functions associated with the function or the service, in place of or in addition to executing the function or the service. The other electronic device, for example, the electronic device 10a and/or 10b or the server 20, may execute the requested function or additional function and deliver the execution result to the electronic device 10. The electronic device 10 may then process or further process the received result to provide the requested function or service. To this end, for example, cloud computing, distributed computing, or client-server computing may be used.

The embodiments disclosed in this document have been provided for description and understanding of disclosed technical matters, without limiting the scope of the present disclosure. Therefore, the scope of the present disclosure should be construed as including all changes or various other embodiments based on the technical spirit of the present disclosure.

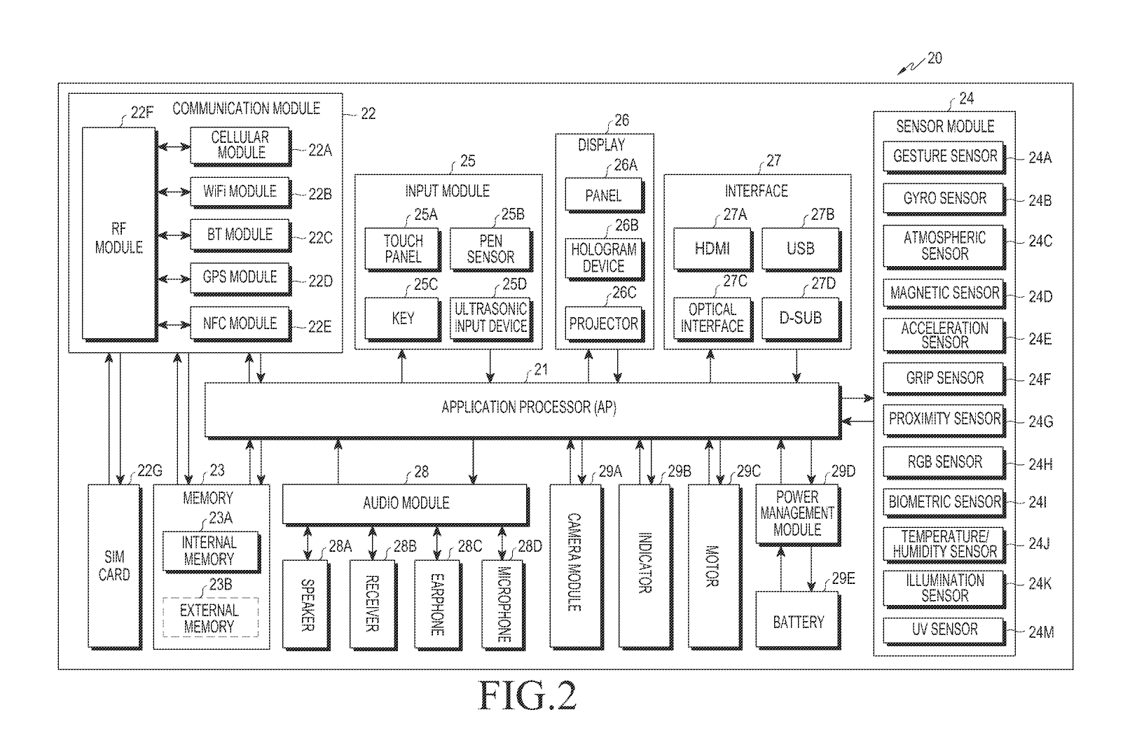

FIG. 2 is a block diagram of an electronic device according to an embodiment of the present disclosure.

Referring to FIG. 2, an electronic device 20 may include a whole or a part of, for example, the electronic device 10 illustrated in FIG. 1. The electronic device 20 may include one or more AP 21, a communication module 22, a subscriber identification module (SIM) card 22G, a memory 23, a sensor module 24, an input device 25, a display 26, an interface 27, an audio module 28, a camera module 29A, an indicator 29B, a motor 29C, a power management module 29D, and a battery 29E.

The AP 21 controls multiple hardware or software components connected to the AP 21 or performs various data processing or operations, for example, by driving an OS or an application program. The AP 21 may be implemented, for example, with a system on chip (SoC). According to an embodiment of the present disclosure, the AP 21 may further include, although not shown, a graphic processing unit (GPU) and/or an image signal processor (ISP). The AP 21 may include at least some, for example, a cellular module 22A, of the components illustrated in FIG. 2. The AP 21 loads a command or data received from at least one of other components, for example, a nonvolatile memory, into a volatile memory to process the command or data, and stores various data in the nonvolatile memory.

The communication module 22 may have a configuration that is the same as or similar to that of the communication interface 17 of FIG. 1. The communication module 22 may include, for example, the cellular module 22A, a wireless fidelity (Wi-Fi) module 22B, a Bluetooth (BT) module 22C, a global positioning system (GPS) module 22D, a near field communication (NFC) module 22E, and a radio frequency (RF) module 22F.

The cellular module 22A provides voice communication, video communication, a text service, or an Internet service over a communication network. According to one embodiment of the present disclosure, the cellular module 22A performs identification and authentication with respect to the electronic device 20 in a communication network by using a subscriber identification module, for example, the SIM card 22G. According to an embodiment of the present disclosure, the cellular module 22A may perform at least some of functions that may be provided by the AP 21. According to an embodiment, the cellular module 22A may include a CP.

Each of the Wi-Fi module 22B, the BT module 22C, the GPS module 22D, and the NFC module 22E may include a processor for processing data transmitted and received there through. According to some embodiments, at least some, for example, two or more, of the cellular module 22A, the Wi-Fi module 22B, the BT module 22C, the GPS module 22D, and the NFC module 22E may be integrated into a single integrated circuit (IC) or IC package.

The RF module 22F transmits and receives, for example, a communication signal, for example, an RF signal. The RF module 22F may include, for example, a transceiver, a power amp module (PAM), a frequency filter, a low noise amplifier (LNA), or an antenna. According to another embodiment of the present disclosure, at least one of the cellular module 22A, the Wi-Fi module 22B, the BT module 22C, the GPS module 22D, and the NFC module 22E transmits and receives an RF signal through a separate RF module.

The SIM card 22G may include, for example, a card including an SIM and/or an embedded SIM, and may include unique identification information, for example, an integrated circuit card identifier (ICCID), or subscriber information, for example, an international mobile subscriber identity (IMSI).

The memory 23, and, for example, the memory 13, may include, for example, an embedded memory 23A or an external memory 23B. The embedded memory 23A may include, for example, at least one of a volatile memory, for example, a dynamic random access memory (DRAM) or synchronous DRAM (SDRAM), a nonvolatile memory, for example, a read only memory (ROM), a one-time programmable ROM (OTPROM), a programmable ROM (PROM), an erasable and programmable ROM (EPROM), an electrically erasable and programmable ROM (EEPROM), a mask ROM, a flash ROM, or a flash memory, such as a NAND flash or a NOR flash, a hard drive, and a solid state drive (SSD).

The external memory 23B may further include a flash drive, for example, a compact flash (CF), a secure digital (SD), a micro-SD, a mini-SD, an extreme digital (xD), or a memory stick. The external memory 23B may be functionally and/or physically connected with the electronic device 20 through various interfaces.

The sensor module 24 measures a physical amount or senses an operation state of the electronic device 20 to convert the measured or sensed information into an electric signal. The sensor module 24 may include, for example, at least one of a gesture sensor 24A, a gyro sensor 24B, an atmospheric sensor 24C, a magnetic sensor 24D, an acceleration sensor 24E, a grip sensor 24F, a proximity sensor 24G, a red, green, blue (RGB) sensor 24H, a biometric sensor 24I, a temperature/humidity sensor 24J, an illumination sensor 24K, and an ultraviolet (UV) sensor 24M. Additionally or alternatively, the sensor module 24 may further include, although not shown, an E-nose sensor, an electromyography (EMG) sensor, an electroencephalogram (EEG) sensor, an electrocardiogram (ECG) sensor, an infrared (IR) sensor, an iris sensor, and/or a fingerprint sensor, which may also be included as a part of the biometric sensor 24I. The sensor module 24 may further include a control circuit for controlling at least one sensors included therein. In some embodiments, the electronic device 20 may further include a processor configured to control the sensor module 24 as a part of or separately from the AP 21, to control the sensor module 24 when the AP 21 is in a sleep state.

The input device 25 may include, for example, a touch panel 25A, a pen sensor 25B, a key 25C, or an ultrasonic input device 25D. The touch panel 25A may use, for example, at least one of a capacitive type, a resistive type, an IR type, and an ultrasonic type. The touch panel 25A may further include a control circuit. The touch panel 25A may further include a tactile layer to provide tactile reaction to a user.

The pen sensor 25B may be, for example, a part of a touch panel or a separate recognition sheet. The key 25C may include, for example, a physical button, an optical key, or a keypad. The ultrasonic input device 25D may sense audio waves and check data through a microphone (MIC), for example, a MIC 28D, in the electronic device 20 through an input means for generating an ultrasonic signal.

The display 26, and, for example, the display 16, may include a panel 26A, a hologram device 26B, or a projector 26C. The panel 26A may have a configuration that is the same as or similar to that of the display 16 of FIG. 1. The panel 26A may be implemented as, for example, being flexible, transparent, or wearable. The panel 26A may be configured as a single module with the touch panel 25A. The hologram device 26B shows a cubic image in the air by using interference of light. The projector 26C displays an image by projecting light onto a screen that may be positioned, for example, inside or outside the electronic device 20. According to an embodiment of the present disclosure, the display 26 may further include a control circuit for controlling the panel 26A, the hologram device 26B, or the projector 26C.

The interface 27 may be, for example, a high-definition multimedia interface (HDMI) 27A, a USB 27B, an optical interface 27C, or a D-subminiature (D-sub) 27D. The interface 27 may be included in, for example, the interface 17 illustrated in FIG. 1. Additionally or alternatively, the interface 27 may include, although not shown, for example, a mobile high-definition link (MHL) interface, a SD card/multimedia card (MMC) interface, or an infrared data association (IrDA) standard interface.

The audio module 28 interchangeably converts sound and an electric signal. At least some components of the audio module 28 may be included in, for example, the I/O interface 15 illustrated in FIG. 1. The audio module 28 may process sound information that is input or output through a speaker 28A, a receiver 28B, an earphone 28C, or the microphone 28D.

The camera module 29A is a device capable of capturing a still image and a moving image, and according to an embodiment, may include, although not shown, one or more image sensors, for example, a front sensor or a rear sensor, a lens, an ISP, or a flash, for example, an LED or a xenon lamp.

The power management module 29D manages power of the electronic device 20. According to an embodiment, the power management module 29D may include a power management integrated circuit (PMIC), a charger IC, or a battery or fuel gauge. The PMIC may use a wired and/or wireless charging scheme. The wireless charging scheme may include, for example, a magnetic resonance scheme, a magnetic induction scheme, or an electromagnetic wave scheme, and an additional circuit for wireless charging, for example, a coil loop, a resonance circuit, or a rectifier may be further included. The battery gauge measures the remaining capacity of the battery 29E, and a voltage, a current, or a temperature of the battery 29E during charging. The battery 29E may include, for example, a rechargeable battery and/or a solar battery.

The indicator 29B displays a specific state, such as a booting state, a message state, or a charging state, of the electronic device 20 or a part thereof, for example, the AP 21. The motor 29C converts an electric signal into mechanical vibration, and generates vibration or a haptic effect. Although not shown, a processing device, for example, a GPU, for supporting a mobile TV may be included. The processing device for supporting the mobile TV processes media data complying with the standard such as digital multimedia broadcasting (DMB), digital video broadcasting (DVB), or a media flow.

Each of the above-described elements of the electronic device may include one or more components, and the name of the element may vary with a type of the electronic device. According to various embodiments, the electronic device may include at least one of the above-described elements, and some elements may be omitted or other elements may be further included. Also, some of the elements of the electronic device according to various embodiments of the present disclosure may be coupled into one entity to perform the same functions of the elements as those of the elements before coupled.

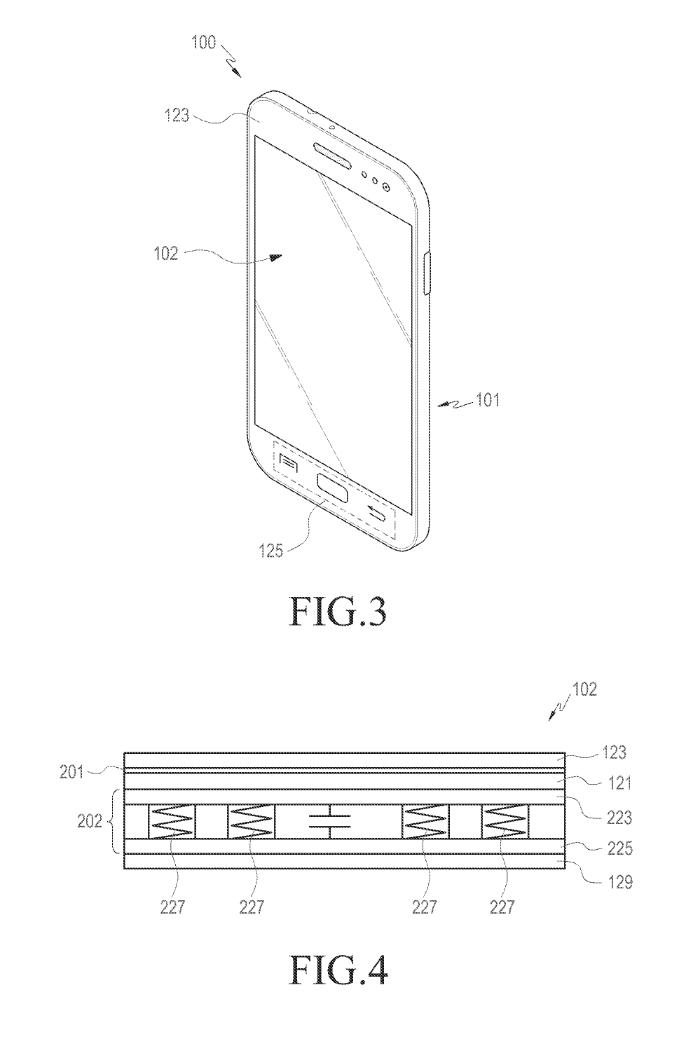

FIG. 3 is a perspective view of an electronic device including a display device according to an embodiment of the present disclosure.

Referring to FIG. 3, according to various embodiments of the present disclosure, an electronic device 100, and, for example, the electronic device 10 shown in FIG. 1, may include a housing or a housing member 101, a window member 123, and a display device 102 (e.g., display 26 shown in FIG. 2). A first surface (e.g., front surface) of the housing member 101 may be opened and may face in a first direction, on which the display device 102 is mounted so as to close and/or occupy the opened front surface of the housing member 101. In an embodiment, the window member 123 may be a transparent glass plate which protects the display device 102 and may form at least a portion of the first surface of the housing member 101. The display device 102 and/or a display panel 121 may be interposed between the window member 123 and a second surface of the housing member 101. The display panel 121 includes a liquid crystal display (LCD) and/or a light emitting diode (LED). The second surface (e.g., rear surface) of the housing member 101 may be closed and may face in a second direction opposite from the first direction.

On the electronic device 100, for example, on the front surface of the housing member 101, a keypad including mechanically operating buttons or touch keys 125 may be provided in a side region of the display device 102. The touch key 125 generates an input signal based on a user's body contact. According to various embodiments of the present disclosure, the keypad may be implemented with mechanical buttons, or the touch keys 125. Inside the housing member 101, various circuit devices, for example, the processor 120, the memory 130, the I/O interface 140, and the communication interface 160 may be received, and a battery may also be received to secure a power source.

FIG. 4 is a cross-sectional view of a display device according to an embodiment of the present disclosure.

Referring to FIG. 4, the display device 102, according to various embodiments of the present disclosure, may include a first touch panel 201 and a second touch panel 202 (e.g., a pressure sensing panel) that are stacked on a display panel 121 (e.g., a display 26 or a panel 26A shown in FIG. 2) outputting a screen, thereby implementing a 3D input. For example, a position, for example, plane coordinates, of a touch input may be calculated through the first touch panel 201 integrated in the display panel 121, and a pressure applied by a touch input is calculated as a digitalized value through the second touch panel 202, such that 3D coordinates are detected from the calculated position of the touch input and the calculated digitalized value.

The display device 102 may include the display panel 121 outputting the screen, and the window member 123 disposed on or over a front surface of the display panel 121. The display device 102 may implement various user experiences, for example, 3D inputs, through a combination of the first touch panel 201 and the second touch panel 202.

In the electronic device 100, the window member 123 is disposed on or over the front surface of the housing member 101 to protect the display panel 121 from an external environment. The display device 102 includes the first touch panel 201 (e.g., the touch panel 25A shown in FIG. 2) integrated in the display panel 121 (e.g., the display 26 shown in FIG. 2), thus being used as an input device as well as an output device. The first touch panel 201 is adhered (or contacts) directly or indirectly onto the front surface, i.e., a surface on which an image output from the display panel 121 is displayed, of the display panel 121 or adhered or formed directly or indirectly on an inner surface of the window member 123. The first touch panel 201 may be implemented with a capacitive touch panel formed of an indium-tin oxide (ITO) film. According to various embodiments of the present disclosure, the first touch panel 201 may be implemented with a resistive touch panel. Such a touch panel detects a change in a capacitance when a user's body contacts or is proximate to the touch panel, thus detecting (or sensing) plane coordinates of a position which the user contacts or is proximate to. Herein, the plane coordinates may refer to coordinates of a position on the front surface of the display panel 121. The first touch panel 201 may be electrically connected to a first control circuit (e.g., the AP 21 shown in FIG. 2).

The touch input may include various gestures as well as a contact or proximity to a particular position. For example, various types of touch inputs may be performed, such as a touch referring to laying a finger on a screen, a tap referring to tapping the screen shortly and lightly, like a single tap, a double tap, a triple tap, a quadruple tap, or the like, a flick referring to moving a finger fast on the screen and then removing the finger from the screen, a drag referring to moving or scrolling a screen element, a drag and drop referring to moving a screen element while touching the screen element and then stopping moving the screen element to remove the finger from the screen, a swipe referring to moving the finger touching the screen a predetermined distance in a direction, a multi-swipe referring to moving two or more fingers touching the screen a predetermined distance, a pinch referring to moving two fingers touching the screen in different directions, a touch and hold referring to keeping a touch state until a screen element appears, or a shake referring to shaking a device for execution of an action.

The second touch panel 202 may be stacked on a rear surface of the display panel 121. For example, the second touch panel 202 may be disposed and stacked on a surface facing the first touch panel 201 with respect to the display panel 121. In the second touch panel 202, conductors 223 and 225, which may also be referred to as conductive patterns or electrodes, face each other, having a spacer 227 formed of an insulating material there between, such that the second touch panel 202 has a touch unit or touch units having a structure like a capacitive element. For example, when a user's body contacts or is proximate to the display device 102, the second touch panel 202 detects a digitalized value for a contact pressure or a proximate distance from a change in a capacitance between the two conductors 223 and 225. In a certain embodiment, the spacer(s) 227 is interposed between the conductors 223 and 225 (e.g., a conductive patterns and a conductive ground plate).

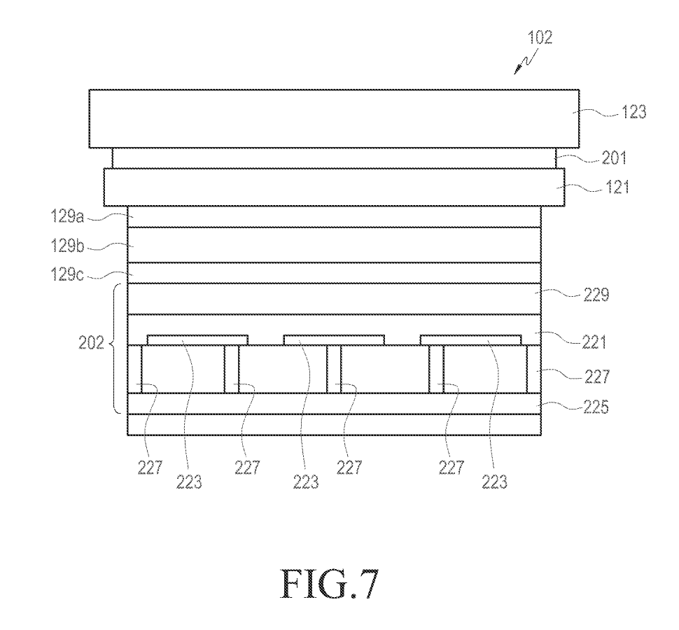

The second touch panel 202 will be described in more detail with reference to FIG. 7. A structure 129, for example, a bracket, a double-side tape, or the like, for supporting or fixing the display panel 121 inside the housing member 101 may be disposed under the second touch panel 202. In an embodiment, the structure 129 is disposed and/or extended substantially parallel to the first touch panel 201 and/or the second touch panel 202 under a conductive pattern of the second touch panel 202 and supports the display panel 121 and/or the second touch panel 202.

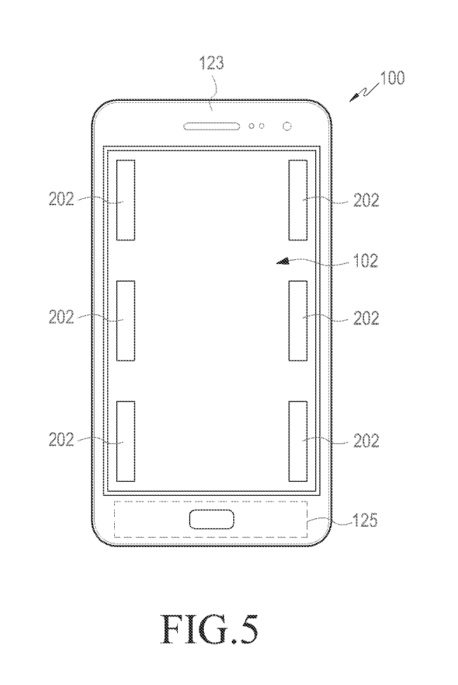

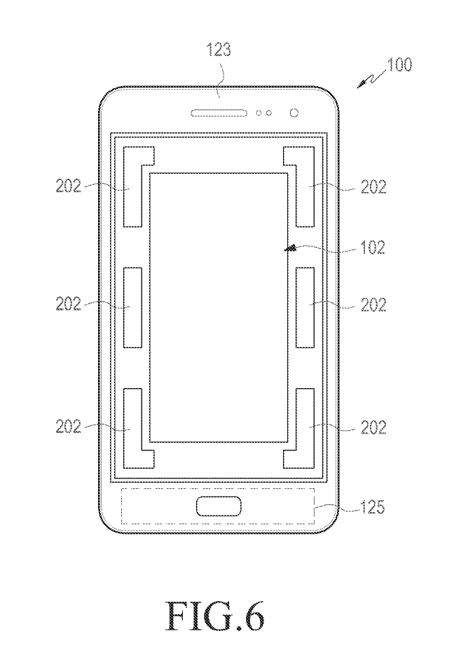

FIG. 5 is a floor plan of an electronic device including a display device according to an embodiment of the present disclosure. FIG. 6 is a floor plan of an electronic device including a display device according to an embodiment of the present disclosure.

Referring to FIGS. 5 and 6, a plurality of second touch panels 202 are arranged along a periphery of a rear surface of the display panel 121. As will be described in more detail below, the number and arrangement of second touch panels 202 on the rear surface of the display panel 121 may vary with specifications of an electronic device, such as the electronic device 100. For example, for a small-size display panel, a contact pressure or a proximate distance may be sufficiently detected merely with one pair or two pairs of pressure sensors. However, if a distance from a contact point of a user's body on a display panel to pressure sensors is long, due to a large size of the display panel, there may be a limitation in accurate detection of a contact pressure. Thus, the number and arrangement of second touch panels 202 may be properly adjusted considering the specifications of an electronic device to be actually manufactured, for example, the size of a display panel of the electronic device. For example, as shown in FIG. 6, one or more of the second touch panels 202 may have a different shape, size, position, or other different characteristics than others of the second touch panels 202.

FIG. 7 is a cross-sectional view of a display device according to an embodiments of the present disclosure.

Referring to FIG. 7, in the display device 102, the first touch panel 201 and the window member 123 are sequentially stacked on the front surface of the display panel 121, and the second touch panels 202 are arranged on the rear surface of the display panel 121, having first through third buffering materials 231a, 231b and 231c between the rear surface of the display panel 121 and the second touch panels 202.

The display panel 121 is a component for outputting a screen, for example, a still image, a moving image, character information, and the like, from among components of the display device 102, and may be manufactured with one of an LCD, an LED display, an OLED display, a MEMS display, an electronic paper display, and the like.

On the front surface of the display panel 121, the first touch panel 201 and the window member 123 may be adhered to each other by using an optical adhesive or the like. The window member 123 passes a screen output by the display panel 121 there through, and protects the first touch panel 201 and the display panel 121. The first touch panel 201 is made of an ITO film, or the like, to pass the screen output by the display panel 121 there through, and to detect plane coordinates of the user's contact or proximate point based on a user input. The first touch panel 201 may form a part of the I/O interface 140. For example, the first touch panel 201 may be included in the I/O interface 140. In a detailed embodiment, for convenience, the first touch panel 201 is illustrated as a component that is separate from the window member 123, but a conductive pattern may be printed onto a surface of the window member 123 to form a panel for detecting a touch input. For example, the window member 123 may form a touch panel.

The first through third buffering materials 231a, 231b and 231c protect the display panel 121 by preventing a direct contact of the display panel 121 with other components, for example, the second touch panel 202. Among the first through third buffering materials 231a, 231b and 231c, the first buffering material 231a may be implemented with a black sheet, a black film and/or black layer and be directly adhered onto a back surface of the display panel 121. In one embodiment, the first buffering material 231a (e.g., a black sheet, a black film and/or black layer) includes an adhesive material. In another embodiment, the first buffering material 231a (e.g., a black sheet, a black film and/or black layer) includes elastic material. In further embodiment, the elastic material includes at least one of sponge, silicon or rubber.

By implementing the first buffering material 231a with a black sheet, the display quality of the display panel 121 may be improved. For example, with a related-art display panel, implementation of the complete black color is limited, but this limitation may be overcome by forming the first buffering material 231a in black and adhering the first buffering material 231a formed in black onto the rear surface of the display panel 121. The second buffering material 231b absorbs a shock that may be generated during assembly of the display device 102 or during mounting of the display device 102 on the housing member 101, and compensates for a component-specific manufacturing tolerance. For example, the second buffering material 231b may be formed of an elastic material such as sponge, silicon, rubber, or the like, to alleviate or absorb a manufacturing tolerance of a predetermined level. The third buffering material 231c may be formed of a double-side tape for adhering the second touch panel 202 onto the rear surface of the display panel 121. In an embodiment, the first through third buffering materials 231a, 231b and 231c are arranged and/or extended in substantially parallel to the display panel 121.

The second touch panel 202 may be implemented to have a structure of a capacitive device by using a plurality of conductive patterns 223 and a conductive ground plate, conductive ground member and/or a ground sheet 225. In an embodiment, the conductive patterns 223 and a conductive ground plate and/or a ground sheet 225 are arranged in substantially parallel to the first surface and/or the second surface of the housing member 101 shown in FIG. 3. In another embodiment, the conductive patterns 223 and a conductive ground plate 225 may have a size substantially the same size of the display panel 121. In further embodiment, the conductive patterns 223 and a conductive ground plate 225 may include conductive metal, for example, copper.

The conductive patterns 223 may be formed as circuit patterns formed on an insulating substrate 221. In one embodiment, the conductive patterns 223 include a repeating pattern of polygons (e.g., rectangular shape or a square shape) across an area between the display panel 121 shown in FIG. 4 and the second surface of the housing member 101. In another embodiment, the conductive pattern 223 may be included a pressure sensing panel (e.g., the second touch panel 202 shown in FIG. 4) and may be disposed under a black sheet (e.g., the first buffering material 231a shown in FIG. 7). For example, the conductive patterns 223 may be arranged on a surface of the insulating substrate 221. According to various embodiment, the insulating substrate 221 (e.g., an insulating sheet, an insulating film and/or an insulating layer) is laminated to (and/or in contact with) the conductive pattern 223. The ground sheet 225 may be formed of a conductive material, such as copper, in the form of a thin film, and may be disposed to face the insulating substrate 221, for example, the conductive patterns 223. To secure a distance between the conductive patterns 223 and the ground sheet 225, one or more of a spacer 227 may be disposed between the insulating substrate 221 and the ground sheet 225. The spacer 227 may be manufactured of an elastic material such as silicon or rubber. In an embodiment, the conductive pattern 223 is uniformly disposed across an area of the pressure sensing panel substantially aligned with the view area of a display (e.g., the display panel 121 shown in FIG. 4) and electrically connected to a second control circuit (e.g., the AP 21 shown in FIG. 2), the second control circuit identifies a pressure of a user's touch input. In an embodiment, the conductive patterns 223 and/or the ground sheet 225 has an area substantially aligned with a view area of the display device 102

As a user's body is proximate to or contacts the display device 102, a capacitance between the conductive patterns 223 and the ground sheet 225 changes, and the second touch panel 202 detects such a capacitance change. The capacitance change differs based on a proximate distance or a contact pressure of the user's body with respect to the display device 102, and the proximate distance or the contact pressure with respect to the display device 102 is calculated based on the capacitance change, thus obtaining vertical coordinates with respect to a surface of the display device 102. In an embodiment, a detected (and/or calculated) information about a location (e.g., plane coordinates) of a touch input and/or a pressure (e.g., the obtained vertical coordinates) of touch input is provided to a main control circuit (e.g., the AP 21 shown in FIG. 2).

To block electric interference between the second touch panel 202 and the display panel 121, or between the second touch panel 202 and the first touch panel 201, the electronic device 100, for example, the second touch panel 202 may further include a shielding member 229. The shielding member 229 may be formed of a conductive metal, e.g., copper thin film and may be used as a heat radiation sheet of the display panel 121. The display panel 121 may generate a predetermined level of heat if operating for a long time, and heat radiation of an electric element may degrade operating performance. The shielding member 229 provides an electrical shielding function between the second touch panel 202 and the display panel 121, and also provides a heat radiation function of dissipating and radiating heat generated by the display panel 121, thereby assisting in and/or providing a stable operation of the display panel 121. The shielding member 229 may be integrated with the insulating substrate 221, and may include an electrode provided on the insulating substrate 221, for example, an electrode to which the same voltage as the conductive patterns 223 is applied. If an electrode is provided in the shielding member 229, the shielding member 229 may form a part of the second touch panel 202.

The second touch panel 202 may be manufactured to include a limited number of, for example, two or three, conductive patterns 223, and may be disposed on or over a surface facing the first touch panel 201, for example, the rear surface of the display panel 121. If the ground sheet 225 has a size corresponding to an entire rear surface of the display panel 121, a pressure sensor may be implemented in which one or more conductive patterns 223 are arranged uniformly over the entire rear surface of the display panel 121. For example, the second touch panel 202 may be disposed on or over the entire rear surface of the display panel 121.

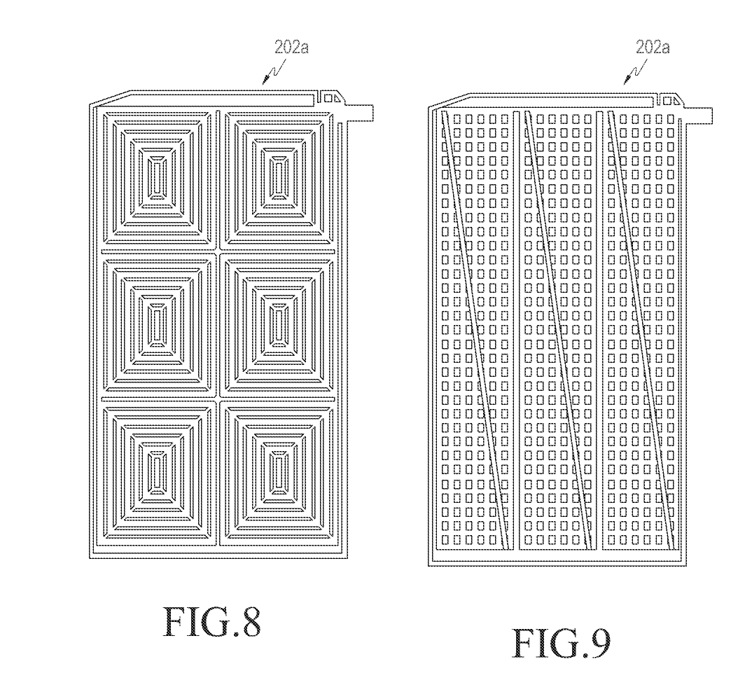

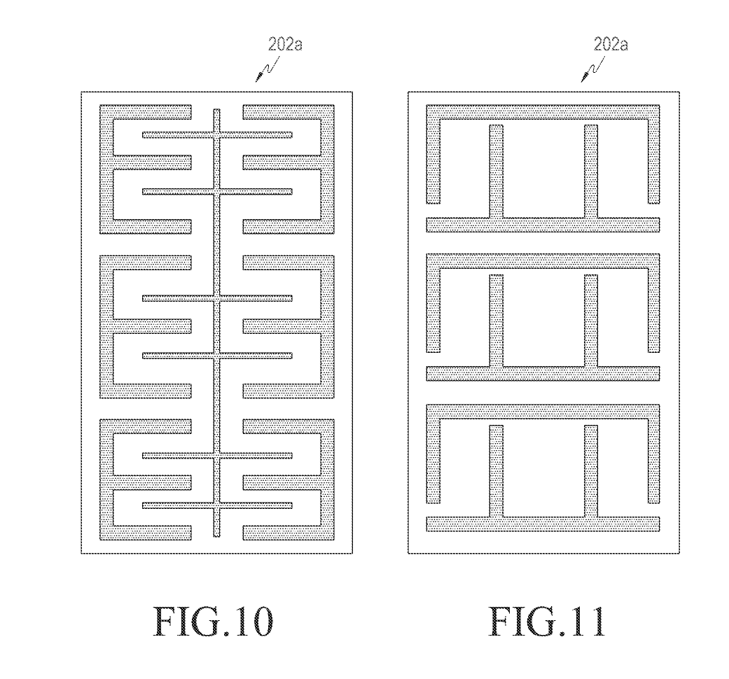

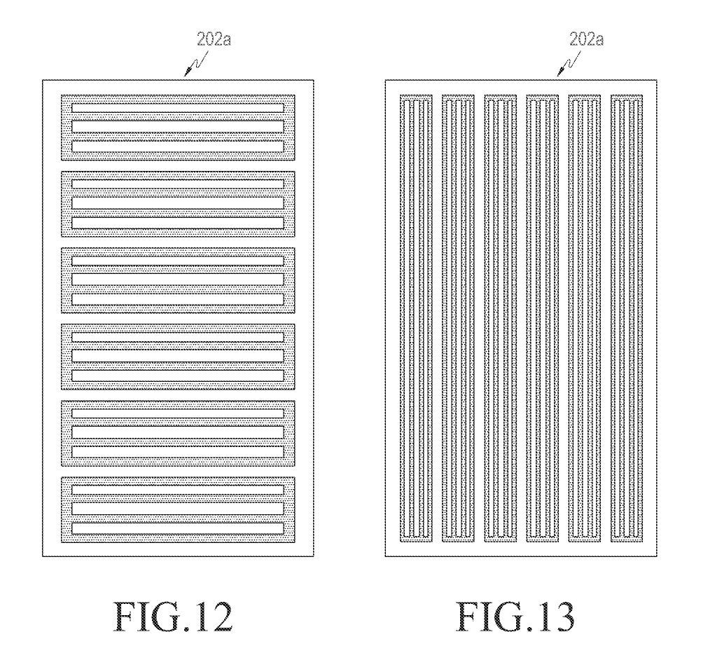

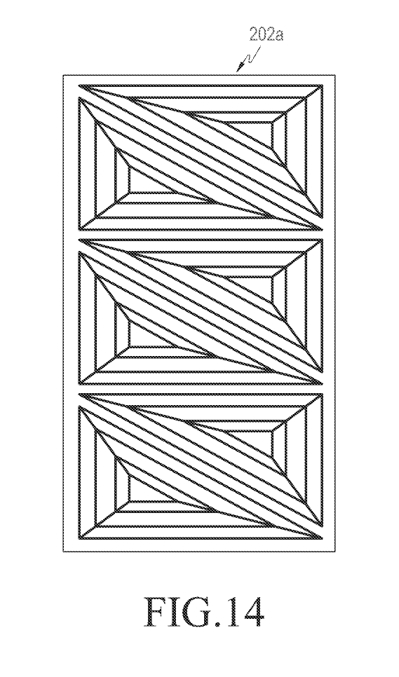

FIGS. 8 through 14 illustrate arrangements of a second touch panel disposed on a display device of an electronic device according to an embodiment of the present disclosure.

Referring to FIG. 8-14, a pressure sensor of a display device are illustrated, for example, arrangements 202a of the second touch panels 202, are illustrated. In the embodiment illustrated in FIGS. 5 and 6, the plurality of second touch panels 202 are arranged along the periphery of the display panel 121. Such a layout of the second touch panels 202 may be useful when the display panel 121 is small, such that the proximate distance or contact pressure of the user's body can be detected regardless of the contact position of the user's body on the display device 102.

Referring to FIGS. 8 through 14, the display device may include a single pressure sensor disposed on or over the entire rear surface of the display panel 121 or the second touch panel having the arrangements 202a of a plurality of pressure sensors. If the single second touch panel 202 is disposed on or over the entire rear surface of the display panel 121, the multiple conductive patterns 223 may be arranged uniformly over the entire rear surface of the display panel 121. The arrangement of the conductive patterns 223 or the arrangement 202a of the second touch panels 202 may have a lattice pattern of various shapes or a repeated pattern of polygons.

As such, the display device 102, according to various embodiments of the present disclosure, calculates a distance of a user's body that is proximate to the display device 102 or a pressure of a contact of the user's body with the display device 102 from a capacitance change or a resistance change detected by the second touch panel 202, and calculates a digitalized value with respect to the display panel 121, for example, vertical coordinates, from the pressure. The plane coordinates detected by the first touch panel 201 and the calculated digitalized value are combined to obtain 3D coordinates, by which a 3D touch input is implemented through the display device 102, providing a new user experience.

The second touch panel 202 may be implemented as a capacitive type, and thus if the first touch panel 201 is implemented as a capacitive touch panel, the second touch panel 202 may be controlled or data detected by the second touch panel 202 may be processed, by using a control circuit chip of the first touch panel 201 or the touch key 125, without a need to add separate control circuit chips.

If the separate control circuit chips are added, a delay may occur due to operation characteristics of each control circuit chip. The delay causes a time difference between the operation of the first touch panel 201 and the operation of the pressure sensor, resulting in a time difference from a user's contact to obtaining of the 3D coordinates. To prevent the delay, an algorithm for synchronizing two or more control circuit chips may be needed, complicating driving of the electronic device.

On the other hand, according to various embodiments of the present disclosure, both the first touch panel 201 and the second touch panel 202 may be controlled and coordinates detected by the first touch panel 201 and the second touch panel 202 may be processed, thus reducing and/or eliminating the delay or time difference. In addition, setting an additional algorithm for synchronization is not needed, thus further facilitating driving of the electronic device while diversifying a user experience provided through the electronic device.

The second touch panel 202 may be adhered to the display panel 121 to serve as a heat radiation sheet, and may also be substituted for at least a part of the buffering materials 231a, 231b and 231c. In this way, while suppressing an increase in the thickness of the display device 102, data, for example, vertical coordinates, detected by the second touch panel is combined with the plane coordinates, thus calculating 3D coordinates. Moreover, since the second touch panel 202 is stacked on the rear surface of the display panel 121, the second touch panel 202 may be installed without securing an additional bezel area. Hence, horizontal and vertical lengths of the display device 102 are prevented from increasing, in spite of disposition of the second touch panel 202.

As described above, an electronic device, according to various embodiments of the present disclosure, includes a display panel, a first touch panel and a second display panel disposed on or over the display panel, a first touch control module electrically connected to the first touch panel to calculate a position of a touch input with respect to the display panel, and a second touch control module electrically connected to the second touch panel to calculate a digitalized value corresponding to a pressure applied by the touch input, in which the first touch control module and the second touch control module are included in one control circuit, and are set to recognize and/or detect the touch input based on the position and the digitalized value.

According to various embodiments of the present disclosure, the first touch panel is disposed on or over a first surface of the display panel on which an image is displayed, and the second touch panel is disposed on a second surface of the display panel, which faces the first surface.

According to various embodiments of the present disclosure, the second touch panel is disposed on or over the entire second surface.

According to various embodiments, the second touch panel is disposed at a periphery of the second surface.

According to various embodiments of the present disclosure, the second touch control module is set to calculate the digitalized value based on a change in a capacitance formed between at least two electrodes included in the second touch panel.

According to various embodiments of the present disclosure, the one control circuit is formed on one flexible printed circuit.

According to various embodiments of the present disclosure, the one flexible printed circuit is adhered to the second touch panel.

According to various embodiments of the present disclosure, the at least two electrodes include a first electrode and a second electrode, and the second touch panel includes a plurality of conductive patterns including the first electrode, a ground sheet including the second electrode, and a spacer disposed between the plurality of conductive patterns and the ground sheet.

According to various embodiments of the present disclosure, the second touch panel further includes a shielding member disposed between the display panel and the plurality of conductive patterns.

According to various embodiments of the present disclosure, the shielding member includes a third electrode to which the same voltage as the first electrode is applied.

According to various embodiments of the present disclosure, the second touch control module is set to change at least one image displayed through the display panel, based on the digitalized value being greater than a predetermined value.

According to various embodiments of the present disclosure, the second touch panel includes a plurality of touch portions, and the second touch control module is set to calculate the digitalized value based on a sum of changes in a capacitance formed between electrodes included in the plurality of touch portions.

As described above, an electronic device, according to various embodiments of the present disclosure is provided and includes a display interposed between a transparent protective window and a pressure sensing panel, a touch panel contacted on the transparent protective window and electrically connected to a first control circuit, the touch panel is configured to sense a touch input and the first control circuit identifies a location of the touch input, black sheet directly adhered onto a back surface of the display, an insulating layer configured to be laminated to a conductive pattern, and the conductive pattern, included in the pressure sensing panel and disposed under the black sheet, uniformly disposed across an area of the pressure sensing panel substantially aligned with the view area of the display and electrically connected to a second control circuit, the second control circuit identifies a pressure of the touch input, wherein the location of the touch input and the pressure of the touch input are provided to a main control circuit as a user input.

According to various embodiments of the present disclosure, the electronic device further includes a supporting structure disposed under the conductive pattern for supporting the pressure sensing panel.

According to various embodiments of the present disclosure, the pressure sensing panel further includes a conductive ground plate interposed between the conductive pattern and the supporting structure, and at least one spacer interposed between the conductive pattern and the conductive ground plate.

According to various embodiments of the present disclosure, the second control circuit detects a change of a capacitance between the conductive pattern and a conductive ground plate to identify the pressure of the touch input.

According to various embodiments of the present disclosure, the conductive ground plate has an area substantially aligned with the view area of the display and the area of the pressure sensing panel.

As described above, an electronic device, according to various embodiments of the present disclosure is provided and includes a housing including a first surface facing in a first direction, and a second surface facing in a second direction opposite from the first direction, a glass plate forming at least a portion of the first surface of the housing, a display interposed between the glass plate and the second surface of the housing, the display including a first surface including a screen and facing in the first direction, and a second surface facing in the second direction, a touch panel integrated into the display, a conductive pattern interposed between the second surface of the display and the second surface of the housing, the conductive pattern is formed substantially parallel to the second surface of the housing, and is spaced apart from the second surface of the display, a first control circuit electrically connected to the touch panel, and a second control circuit electrically connected to the conductive pattern, wherein the first control circuit is configured to detect a touch input for selecting a position on the display, based at least partially on a change in capacitance associated with the touch panel, wherein the second control circuit is configured to detect pressure of the touch input against the glass plate, based at least partially on a change in capacitance associated with the conductive pattern, and wherein the conductive pattern includes a repeating pattern of polygons across an area between the second surface of the display and the second surface of the housing.

According to various embodiments of the present disclosure, the electronic device further includes a black layer interposed between the second surface of the display and the conductive pattern, wherein the black layer extends substantially parallel to the second surface of the display.

According to various embodiments of the present disclosure, the electronic device further includes an insulating substrate interposed between the black layer and the conductive pattern, wherein the insulating substrate is in contact with at least a portion of the conductive pattern.

According to various embodiments of the present disclosure, the black layer includes an adhesive material.

According to various embodiments of the present disclosure, the black layer includes an elastic material.

According to various embodiments of the present disclosure, the elastic material includes at least one of sponge, silicon or rubber.

According to various embodiments of the present disclosure, the electronic device further includes a conductive ground member interposed between the touch panel and the second surface of the housing, wherein the second control circuit is configured to detect pressure of the touch input, based at least partially on a change in capacitance formed between the conductive pattern and the conductive ground member.

According to various embodiments of the present disclosure, the conductive ground member has a size substantially the same as a size of the second surface of the display.

According to various embodiments of the present disclosure, the conductive ground member includes copper.

According to various embodiments of the present disclosure, the electronic device further includes a spacer at a periphery of the conductive pattern, wherein the spacer is coupled to at least a portion of the conductive pattern.

According to various embodiments of the present disclosure, the electronic device further includes a supporting structure interposed between the conductive pattern and the second surface of the housing, wherein the supporting structure extends substantially parallel to the conductive pattern.

According to various embodiments of the present disclosure, the electronic device further includes a conductive shielding member interposed between the second surface of the display and the conductive pattern, wherein the conductive shielding member at least partially shields an electrical interference between the display and the conductive pattern.

According to various embodiments of the present disclosure, the conductive shielding member is positioned to dissipate at least part of heat generated by the display.

According to various embodiments of the present disclosure, the electronic device further includes a third control circuit electrically connected to the first control circuit and the second control circuit, wherein the third control circuit includes an application processor, and a memory, wherein the memory stores instructions that, when executed, cause the application processor to receive first information associated with the detected position of the touch input from the first control circuit, receive second information associated with the detected pressure of the touch input from the second control circuit, and perform an action based at least partially on the first information and the second information.

According to various embodiments of the present disclosure, the touch panel includes indium-tin oxide (ITO).

According to various embodiments of the present disclosure, the at least one of the polygons includes a rectangular shape or a square shape.

According to various embodiments of the present disclosure, the display includes a liquid crystal display (LCD) or a light emitting diode (LED) display.

According to various embodiments of the present disclosure, the electronic device further includes a conductive ground member interposed between the touch panel and the second surface of the housing, wherein the second control circuit is configured to detect pressure of the touch input, based at least partially on a change in capacitance according to a change in gap between the conductive pattern and the conductive ground member.

As described above, an electronic device, according to various embodiments of the present disclosure, includes a housing including a first surface facing in a first direction, and a second surface facing in a second direction opposite from the first direction, a window member forming at least a portion of the first surface of the housing, and a display panel disposed between the window member and the second surface of the housing, wherein the display panel includes a first surface including a screen and facing in the first direction, and a second surface facing in the second direction, a touch panel integrated into the display panel, a conductive pattern disposed between the second surface of the display panel and the second surface of the housing, wherein the conductive pattern is formed substantially parallel to the second surface of the housing, and is spaced apart from the second surface of the display panel, a first touch control module electrically connected to the touch panel, and a second touch control module electrically connected to the conductive pattern, wherein the first touch control module is configured to detect a position of a touch input on the glass plate, based at least partially on a change in capacitance associated with the touch panel, wherein the second touch control module is configured to detect pressure of the touch input against the glass plate, based at least partially on a change in capacitance associated with the conductive pattern, and wherein the conductive pattern includes a repeating pattern of polygons across a planar area between the second surface of the display panel and the second surface of the housing.

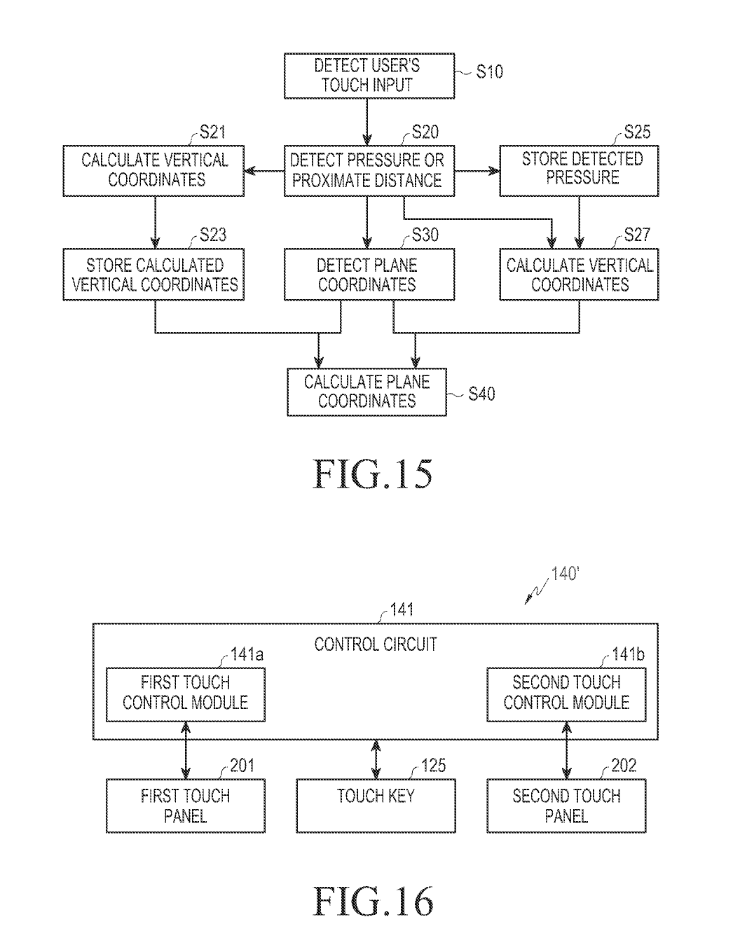

FIG. 15 is a flowchart of a 3D input method for an electronic device according to an embodiment of the present disclosure. FIG. 16 is a block diagram of an I/O interface associated with an electronic device according to an embodiment of the present disclosure.

Referring to FIGS. 15 and 16, when a 3D input method is described, structures of an electronic device and a display device mounted thereon will refer to the above-described structures of the foregoing embodiments of the present disclosure.

The 3D input method using the display device 102 may include operation S10 of detecting a user's touch input, operation S20 of detecting a pressure applied in a contact, or a proximate distance, to the display device 102, operation S30 of detecting plane coordinates of a position contacting, or being proximate to, the display device 102, operations S21 and S27 of calculating vertical coordinates from the detected pressure or the proximate distance, and operation S40 of calculating 3D coordinates by combining the plane coordinates with the vertical coordinates. According to various embodiments of the present disclosure, the detected pressure may be temporarily stored in a control circuit 141 (see FIG. 16) in operation S25, and/or the calculated vertical coordinates may be temporarily stored in the control circuit 141 in operation S23, and when a 3D input is requested, vertical coordinates may be calculated or output from the stored data.

As shown in FIG. 16, an I/O interface 140′ may include the control circuit 141, which may include a first touch control module (e.g., the first control circuit as mentioned above) 141a and a second touch control module (e.g., the second control circuit as mentioned above) 141b. In an embodiment, the control circuit 141 may further include a third touch control module electrically connected to the first touch control module 141a and/or the second touch control module 141b. In another embodiment, the third touch control module included in the control circuit 141 may include the AP 21 shown in FIG. 2.

The first touch control module 141a is electrically connected to the first touch panel 201 to calculate and/or detect a touch input for selecting a position on the display panel 121, based at least partially on a change in capacitance associated with a touch panel (e.g., the first touch panel 201). The position of the touch input may be horizontal coordinates that are set on the display panel 121.

The second touch control module 141b is electrically connected to the second touch panel 202 to calculate and/or detect a digitalized value corresponding to a pressure applied by the touch input, based at least partially on a change in a capacitance formed between at least two electrodes included in the second touch panel 202. The digitalized value calculated by the second touch control module 141b may be vertical coordinates along a direction perpendicular to a surface of the display panel 121. At least one of the first touch control module 141a, the second touch control module 141b, and/or the third touch control module can be implemented in a form of a circuit. According to various embodiment of the presented disclosure, the I/O interface 140′ may include a memory (e.g., the memory 23 shown in FIG. 2). In one embodiment, the memory stores instructions that, when executed, cause the application processor to receive first information associated with the detected position of the touch input from the first control circuit, receive second information associated with the detected pressure of the touch input from the second control circuit, and perform an action based at least partially on the first information and the second information.

In an embodiment, when a touch input on a glass plate (e.g., the window member 123 shown in FIG. 3) is received, Operation S10 of detecting the touch input involves detecting whether a touch is input when the display device 102 is in an active state. For a display device having a first touch panel mounted thereon, the first touch panel is activated simultaneously with activation of the display device, such that a user's touch input may be continuously monitored. According to various embodiments of the present disclosure, the first touch panel 201 may be implemented as a capacitive or resistive touch panel. If the first touch panel 201 is implemented as a capacitive touch panel, a hovering state, in which a proximate state within a predetermined distance from the display device 102 is maintained for a predetermined time without a direct contact to the display device 102, may be recognized as a touch input.

Operation S20 of detecting the pressure involves detecting a pressure at which the user presses the display device 102, in which an distance between the conductive pattern 223 and the ground sheet 225 changes according to the pressure applied by the user. If the distance between the conductive pattern 223 and the ground sheet 225 changes, the capacitance of the second touch panel 202 also changes, and the pressure applied by the user may be detected from the capacitance change. The second touch control module 141b calculates a digitalized value from the detected pressure.

The operation S30 of detecting the plane coordinates involves detecting and/or sensing plane coordinates of a position at which the user's body is proximate to or makes contact with the display device 102, for example, the front surface of the display panel 121. Once the user's touch input is sensed, the first touch control module 141a calculates a position of the touch input from a capacitance change or the like. As mentioned previously, if the user's body is proximate to the display device 102 within a predetermined distance, without directly contacting the display device 102, then the first touch panel 201 recognizes such a state as a touch input and the first touch control module 141a detects the proximate position in the form of plane coordinates.

The operation S20 of detecting the pressure and the operation S30 of detecting the plane coordinates are not necessarily executed sequentially. For example, since the first touch control module 141a detects the plane coordinates through the first touch panel 201 and the second touch control module 141b detects a digitalized value from the pressure detected by the second touch panel 202, the order of execution is not necessarily specified. According to various embodiments of the present disclosure, the operation S30 of detecting the plane coordinates may be executed prior to and/or after the operation S20 of detecting the pressure. To calculate the 3D coordinates and use the calculated 3D coordinates as an input, the operation S20 of detecting the pressure and the operation S30 of detecting the plane coordinates may be performed at the same time.

The operations S21 and S27 of calculating the vertical coordinates may be performed independently of the operation S30 of detecting the plane coordinates. The vertical coordinates are calculated based on the pressure applied by the user in the contact to the display device 102, and may be calculated using different equations according to the specifications of the second touch panel 202. The pressure detected from the second touch panel 202 and the vertical coordinates may have a proportional relationship. For example, if various forms of contents are arranged on a 3D image, contents positioned at a lower position among the contents arranged on the 3D image may be selected when the user contacts the display device 102 at a higher contact pressure. If the plurality of second touch panels 202 are arranged on the rear surface of the display panel 121, vertical coordinates may be calculated from a sum of pressures detected by the respective second touch panels 202. In addition, if a gesture, such as a drag, rather than a simple contact, with respect to the display device 102 is generated, such a touch input, like a drag or the like, may be implemented as a 3D input from a change in the pressure detected by each second touch panel 202. For example, by comparing a position at which the touch input is terminated and a pressure at the time of termination with a position at which the touch input starts and a pressure at the time of start, the drag may be implemented three-dimensionally.

According to various embodiments of the present disclosure, data regarding the pressure detected by the second touch panel 202 or the digitalized value calculated from the detected pressure may be temporarily stored in the control circuit 141. The control circuit 141 controls the first touch panel 201, the touch key 125, or the second touch panel 202 directly or through the first touch control module 141a and the second touch control module 141b, and detects a user's touch input according to a signal generated from the first touch panel 201, the touch key 125, or the second touch panel 202. The control circuit 141 may be any one of a touch IC for controlling the first touch panel 201 and a touch key IC for controlling the touch key, and the second touch panel 202 may be controlled through the control circuit 141. The control circuit 141 may be implemented as a flexible printed circuit and may be adhered to the second touch panel 202, for example, the ground sheet 225 or the insulating substrate 221.

The operation S40 of calculating the 3D coordinates involves recognizing a touch input based on a touch position calculated by the first touch control module 141a and a digitalized value calculated from the second touch control module 141b. The digitalized value may indicate vertical coordinates with respect to the display panel. The digitalized value calculated by the second touch control module 141b from the pressure detected by the second touch panel 202 may be stored in the control circuit 141, and if necessary, for example, when a 3D input is requested, the digitalized value may be output to be combined with the plane coordinates detected by the first touch panel 201. For example, the control circuit 141 calculates the vertical coordinates from the stored digitalized value and outputs the calculated vertical coordinates, or outputs the stored vertical coordinates and combines the vertical coordinates with the plane coordinates detected by the first touch panel 201 to calculate 3D coordinates.

The second touch control module 141a may change at least one image displayed on the display panel 121, based on the calculated digitalized value being greater than a specific value. For example, if the user applies a gradually increasing pressure while dragging on an execution window of a currently executed application, then the control circuit 141 reduces a corresponding screen, i.e., reduces a corresponding screen size, and moves the screen to a position at which the drag is stopped.

According to various embodiments of the present disclosure, the display device 102 may output a 2D image or may output contents arranged on a 2D plane. If the display device 102 outputs an image or a contents arrangement in the form of a 2D plane, the second touch panel 202 may be in an inactive state. Even when the second touch panel 202 is activated and detects a user's contact pressure, data regarding the pressure or vertical coordinates stored in the control circuit is not output and an input operation is performed based on the plane coordinates detected by the first touch panel 201, if a 3D input is not necessary.

According to various embodiments of the present disclosure, if the second touch panel 202 includes a plurality of touch portions, i.e., facing electrodes, or a plurality of second touch panels 202 are arranged, then the second touch control module 141b calculates a digitalized value from a sum of capacitance changes sensed by the respective touch portions or second touch panels 202. For example, the second touch panel 202 may alone calculate horizontal coordinates. The pressure applied by the user's touch input may be distributed over the entire display panel without concentrating on a contact position, but the pressure applied to the contact position may be highest. If the second touch panels 202 are distributed uniformly over the entire display panel, the second touch control module 141b may compare the pressures detected by the respective touch panels 202 and positions corresponding thereto, and recognize that a touch input is made at a position at which the detected pressure is highest. In an embodiment, a controller and/or a processor (e.g., the AP 21 shown in FIG. 2) perform an action based at least partially on the digitalized value (e.g., the detected position of the touch input and/or the detected pressure of the touch input)

According to various embodiments of the present disclosure, a method for controlling an electronic device including a first touch panel and a second touch panel, which are disposed on or over a display panel, includes calculating a position of a touch input to the display panel through the first touch panel, detecting a pressure corresponding to a pressure applied by the touch input through the second touch panel, and calculating a digitalized value from the detected pressure, in which the touch input is recognized based on the calculated position of the touch input and the calculated digitalized value.

According to various embodiments of the present disclosure, the pressure is detected based on a change in a capacitance formed between at least two electrodes included in the second touch panel.

According to various embodiments of the present disclosure, the method may further include changing at least one image displayed through the display panel, based on the digitalized value being greater than a predetermined value.

According to various embodiments of the present disclosure, the position of the touch input is detected as horizontal coordinates on the display panel.

According to various embodiments of the present disclosure, the digitalized value indicates vertical coordinates with respect to a surface of the display panel.

The display device, according to various embodiments of the present disclosure, may detect a value, for example, a digitalized value, a pressure, or the like, corresponding to a user's touch input by using the first and second touch panels stacked on the display panel and calculate horizontal and vertical coordinates based on the value, thus implementing a 3D touch input. Hence, through a combination of the first touch panel and the second touch panel, various user experiences may be provided. In addition, the second touch panel is stacked with the display panel, such that increases in the width and length of the display device may be substantially avoided. Moreover, on the rear surface of the display panel, a pressure sensor may serve as a heat radiation sheet and a buffering material, suppressing an increase in the thickness of the display device.

As described above, a method for operating the electronic device, according to various embodiments of the present disclosure is provided and includes operations for receiving a touch input on the glass plate, detecting a position of the touch input, using the first control circuit, based at least partially on a change in capacitance associated with the touch panel, detecting pressure of the touch input against the glass plate, using the second control circuit, based at least partially on a change in capacitance associated with the conductive pattern, and performing an action based at least partially on the detected position of the touch input and the detected pressure of the touch input.

Other effects that may be obtained or expected from the embodiments of the present disclosure are explicitly or implicitly disclosed in the detailed description of the embodiment of the present disclosure. For example, various effects expected from the embodiments of the present disclosure have been disclosed in the detailed description of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device capable of detecting a touch and a pressure, comprising:
a display interposed between a transparent protective window and a pressure sensing panel;
a touch panel contacted on the transparent protective window and electrically connected to a first control circuit, the touch panel is configured to sense a touch input and the first control circuit identifies a location of the touch input;
a black sheet directly adhered onto a back surface of the display;
an insulating layer configured to be laminated to a conductive pattern; and
the conductive pattern, included in the pressure sensing panel and disposed under the black sheet, uniformly disposed across an area of the pressure sensing panel substantially aligned with the view area of the display and electrically connected to a second control circuit, the second control circuit identifies a pressure of the touch input;
wherein the location of the touch input and the pressure of the touch input are provided to a main control circuit as a user input.

2. The electronic device of claim 1, further comprising:
a supporting structure disposed under the conductive pattern for supporting the pressure sensing panel.

3. The electronic device of claim 2, wherein the pressure sensing panel further comprises:
a conductive ground plate interposed between the conductive pattern and the supporting structure; and
at least one spacer interposed between the conductive pattern and the conductive ground plate.

4. The electronic device of claim 1, wherein the second control circuit detects a change of a capacitance between the conductive pattern and a conductive ground plate to identify the pressure of the touch input.

5. The electronic device of claim 4, wherein the conductive ground plate has an area substantially aligned with the view area of the display and the area of the pressure sensing panel.

6. An electronic device comprising:
a housing including a first surface facing in a first direction, and a second surface facing in a second direction opposite from the first direction;
a glass plate forming at least a portion of the first surface of the housing;
a display interposed between the glass plate and the second surface of the housing, the display including a first surface including a screen and facing in the first direction, and a second surface facing in the second direction;
a touch panel integrated into the display;
a conductive pattern interposed between the second surface of the display and the second surface of the housing, the conductive pattern is formed substantially parallel to the second surface of the housing, and is spaced apart from the second surface of the display;
a first control circuit electrically connected to the touch panel; and
a second control circuit electrically connected to the conductive pattern,
wherein the first control circuit is configured to detect a touch input for selecting a position on the display, based at least partially on a change in capacitance associated with the touch panel,
wherein the second control circuit is configured to detect pressure of the touch input against the glass plate, based at least partially on a change in capacitance associated with the conductive pattern,
wherein the conductive pattern includes a repeating pattern of polygons across an area between the second surface of the display and the second surface of the housing.

7. The device of claim 6, further comprising:
a black layer interposed between the second surface of the display and the conductive pattern,
wherein the black layer extends substantially parallel to the second surface of the display.

8. The device of claim 7, further comprising:
an insulating substrate interposed between the black layer and the conductive pattern,
wherein the insulating substrate is in contact with at least a portion of the conductive pattern.

9. The device of claim 7, wherein the black layer includes an adhesive material.

10. The device of claim 7, wherein the black layer includes an elastic material.

11. The device of claim 10, wherein the elastic material includes at least one of sponge, silicon or rubber.

12. The device of claim 6, further comprising:
a conductive ground member interposed between the touch panel and the second surface of the housing,
wherein the second control circuit is configured to detect pressure of the touch input, based at least partially on a change in capacitance formed between the conductive pattern and the conductive ground member.

13. The device of claim 12, wherein the conductive ground member has a size substantially the same as a size of the second surface of the display.

14. The device of claim 12, wherein the conductive ground member includes copper.

15. The device of claim 6, further comprising:
a spacer at a periphery of the conductive pattern, wherein the spacer is coupled to at least a portion of the conductive pattern.

16. The device of claim 6, further comprising:
a supporting structure interposed between the conductive pattern and the second surface of the housing,
wherein the supporting structure extends substantially parallel to the conductive pattern.

17. The device of claim 6, further comprising:
a conductive shielding member interposed between the second surface of the display and the conductive pattern,
wherein the conductive shielding member at least partially shields an electrical interference between the display and the conductive pattern.

18. The device of claim 17, wherein the conductive shielding member is positioned to dissipate at least part of heat generated by the display.

19. The device of claim 6, further comprising:
a third control circuit electrically connected to the first control circuit and the second control circuit,
wherein the third control circuit includes an application processor, and a memory,
wherein the memory stores instructions that, when executed, cause the application processor to:
receive first information associated with the detected position of the touch input from the first control circuit;
receive second information associated with the detected pressure of the touch input from the second control circuit; and
perform an action based at least partially on the first information and the second information.

20. The device of claim 6, wherein the touch panel includes indium-tin oxide (ITO).

21. The device of claim 6, wherein at least one of the polygons includes a rectangular shape or a square shape.

22. The device of claim 6, wherein the display includes a liquid crystal display (LCD) or a light emitting diode (LED) display.

23. The device of claim 6, further comprising:
a conductive ground member interposed between the touch panel and the second surface of the housing,
wherein the second control circuit is configured to detect pressure of the touch input, based at least partially on a change in capacitance according to a change in gap between the conductive pattern and the conductive ground member.

24. An electronic device comprising:
a housing including a first surface facing in a first direction, and a second surface facing in a second direction opposite from the first direction;
a window member forming at least a portion of the first surface of the housing; and
a display panel disposed between the window member and the second surface of the housing, the display panel includes a first surface including a screen and facing in the first direction, and a second surface facing in the second direction;
a touch panel integrated into the display panel;
a conductive pattern disposed between the second surface of the display panel and the second surface of the housing, the conductive pattern is formed substantially parallel to the second surface of the housing, and is spaced apart from the second surface of the display panel;
a first touch control module electrically connected to the touch panel; and
a second touch control module electrically connected to the conductive pattern,
wherein the first touch control module is configured to detect a position of a touch input on the glass plate, based at least partially on a change in capacitance associated with the touch panel,
wherein the second touch control module is configured to detect pressure of the touch input against the glass plate, based at least partially on a change in capacitance associated with the conductive pattern,
wherein the conductive pattern includes a repeating pattern of polygons across a planar area between the second surface of the display panel and the second surface of the housing.

25. A method for operating the device of claim 6, the method comprising:
receiving a touch input on the glass plate;
detecting a position of the touch input, using the first control circuit, based at least partially on a change in capacitance associated with the touch panel;
detecting pressure of the touch input against the glass plate, using the second control circuit, based at least partially on a change in capacitance associated with the conductive pattern; and
performing an action based at least partially on the detected position of the touch input and the detected pressure of the touch input.
